(19) United States
(12) Patent Application Publication
(10) Pub. No.: US 2013/0286480 A1
(43) Pub. Date: Oct. 31, 2013

(54) RETARDATION PLATE AND ELECTRONIC APPARATUS

(71) Applicant: SEIKO EPSON CORPORATION, Tokyo (JP)

(72) Inventor: Takenori Hirota, Chiba-shi (JP)

(73) Assignee: Seiko Epson Corporation, Tokyo (JP)

(21) Appl. No.: 13/868,524

(22) Filed: Apr. 23, 2013

(30) Foreign Application Priority Data
Apr. 26, 2012 (JP) 2012100772

(51) Int. Cl. G02B 5/30; G02B 1/08

(52) U.S. Cl. CPC G02B 5/3083; G02B 1/08
USPC 359/492.01

(57) ABSTRACT

A retardation plate includes a first substrate, a retardation film disposed on the first substrate, a second substrate larger than the first substrate and covering the retardation film, a third substrate disposed such that the first substrate lies between the second substrate and the third substrate, and an inorganic sealing member air-tightly binding the second substrate and the third substrate together so as to air-tightly enclose the retardation film.

### BACKGROUND

1. Technical Field

The present invention relates to a retardation plate and an electronic apparatus including the retardation plate.

2. Related Art

A projector using a liquid crystal panel as an optical modulator includes a retardation plate that is an optical component for changing phase difference. For example, in order to increase the brightness of a projector including a transmissive liquid crystal panel, light from a light source is divided into P waves and S waves, and the P waves are converted into S waves by rotating 90° the polarization axis of the P waves through a retardation plate. Since the retardation plate of the projector is exposed to strong light, inorganic vapor-deposited films formed by obliquely vapor-depositing a light-resistant heat-resistant inorganic material, such as SiO₂, are used as the retardation plate.

For example, JP-A-2008-180865 discloses a method for forming an inorganic retardation film. The inorganic retardation film formed by this method includes a plurality of oblique columns (columnar structures) tilted with respect to the surface of the substrate and is porous because of pores formed between the oblique columns. Also, the inorganic retardation film is made of SiO₂ or any other highly polar material and is liable to adsorb water. The retardation characteristics of such an inorganic retardation film are changed by the adsorption of water to the inorganic retardation film. Accordingly, the inorganic retardation film is prevented from being affected by external moisture (being penetrated by water).

In order to reduce the influence of external moisture, an optical component disclosed in, for example, JP-A-2010-117537 is proposed. This optical component includes a polarizer made of an organic material and a retardation film (organic retardation film). The polarizer and the retardation film are air-tightly enclosed so as not to contact with external air by two transparent substrates and a sealing member. The sealing member is an organic material having a water-vapor permeability of 60 g/m²·24 h or less and can protect the optical component from external moisture.

However, when the technique of JP-A-2010-117537 is applied to an inorganic retardation plate, the retardation characteristics of the inorganic retardation film are undesirably varied by external moisture. More specifically, since the inorganic retardation film is made of a water-adsorbent highly polar material and has a porous structure, which tends to absorb and hold water, the inorganic retardation film is more easily affected by moisture than the organic retardation film. Accordingly, the inorganic retardation film is affected even by so small an amount of water (moisture) as the organic retardation film is not affected, and consequently the retardation characteristics are varied. Thus, the technique of JP-A-2010-117537 does not reduce the influence of external moisture on the inorganic retardation film, and its retardation characteristics are varied.

### SUMMARY

The invention has been made to solve at least part of the above issues, and the following embodiments, or applications, of the invention can be provided.

A retardation plate of an embodiment includes a first substrate, a retardation film disposed on the first substrate, a second substrate larger than the first substrate when viewed from above and covering the retardation film, a third substrate disposed such that the first substrate lies between the second substrate and the third substrate, and a frame-shaped inorganic sealing member disposed between the edge of the second substrate and the retardation film. The inorganic sealing member air-tightly binds the second substrate and the third substrate together so as to air-tightly enclose the retardation film.

In the retardation plate, since the retardation film is air-tightly enclosed by the moisture-resistant second and third substrates and inorganic sealing member and isolated from external air, the retardation film is substantially not affected by external moisture (moisture penetration). Accordingly, the retardation characteristics are not varied (degraded) by external moisture. Thus, the retardation plate is resistant to moisture.

A retardation plate of another embodiment includes a first substrate, a retardation film disposed on the first substrate, a second substrate disposed such that the retardation film lies between the first substrate and the second substrate, and a frame-shaped inorganic sealing member disposed between the edge of the first substrate and the retardation film. The inorganic sealing member air-tightly binds the first substrate and the second substrate together so as to enclose the retardation film.

In this retardation plate, since the retardation film is air-tightly enclosed by the moisture-resistant first and second substrates and inorganic sealing member and isolated from external air, the retardation film is substantially not affected by external moisture (moisture penetration). Accordingly, the retardation characteristics are not varied (degraded) by external moisture. Thus, the retardation plate is resistant to moisture.

In the above embodiments, preferably, the inorganic sealing member is made of a metal or a low melting point having a lower melting point than the first substrate.

The low melting point glass may have a water-vapor permeability of about 10⁻⁶ g/m²·24 h or less and is thus resistant to moisture. The metal also has as high moisture resistance as the low melting point glass. By using the inorganic sealing member made of a moisture-resistant metal or low melting point glass for air-tight sealing, the influence of external air is reduced.

The retardation film is preferably an inorganic vapor-deposited film formed on the first substrate by oblique vapor deposition.

By forming an inorganic vapor-deposited retardation film in a region air-tightly sealed with the moisture-resistant inorganic sealing member and thus protected from external moisture, the retardation plate can exhibit heat resistance and light resistance, which are advantageous characteristics of inorganic vapor-deposited films, while the disadvantages of the inorganic vapor-deposited film are eliminated.

The retardation plate may further include a resin member between the first substrate and the inorganic sealing member.

By providing the resin member in the gap between the first substrate and the inorganic sealing member, air is expelled from the gap. Thus, the inorganic sealing member is prevented from being pressed and damaged by thermal expansion of the air in the gap caused by heating in the course of forming the inorganic sealing member.

Preferably, the first substrate and the second substrate have the same linear expansion coefficient.

Thus, the retardation plate is prevented from being deformed by the difference in thermal expansion between the first substrate and the second substrate.

Preferably, the first substrate, the second substrate and the third substrate have the same linear expansion coefficient.

Thus, the retardation plate is prevented from being deformed by the difference in thermal expansion among the first, second and third substrates.

In the former embodiment, preferably, the retardation plate further includes an antireflection film on at least either the surface of the second substrate opposite the first substrate or the surface of the third substrate opposite the first substrate.

Since the surface of the second and third substrates through which light enters is provided with the antireflection film to prevent reflection, light passing through the retardation plate is prevented from being attenuated by reflection. Thus, the presence of the antireflection film increases the light transmittance of the retardation plate.

In the latter embodiment, preferably, the retardation plate further includes an antireflection film on at least one of the surface of the first substrate opposite the retardation film and the surface of the second substrate opposite the first substrate.

Since the surface of the first and second substrates through which light enters is provided with the antireflection film to prevent reflection, light passing through the retardation plate is prevented from being attenuated by reflection. Thus, the presence of the antireflection film increases the light transmittance of the retardation plate.

According to still another aspect of the invention, an electronic apparatus including the retardation plate is provided.

Since the retardation plate is resistant to moisture and the retardation characteristics of the retardation plate are not affected by external moisture, the electronic apparatus can exhibit superior display performance, and such an electronic apparatus can be a projector, a rear projection TV set, a DVD recorder, a CD recorder and so forth.

### BRIEF DESCRIPTION OF THE DRAWINGS

The invention will be described with reference to the accompanying drawings, wherein like numbers reference like elements.

FIGS. 1A and 1B are schematic views of a retardation plate according to a first embodiment of the invention.

FIG. 2 is a schematic enlarged view of the retardation film of the retardation plate according to the first embodiment.

FIG. 3 is a flow diagram of a method for manufacturing the retardation plate of the first embodiment, showing the process steps of the method.

FIGS. 4A and 4B are schematic views of a retardation plate according to a second embodiment of the invention.

FIG. 5 is a flow diagram of a method for manufacturing the retardation plate of the second embodiment, showing the process steps of the method.

FIGS. 6A and 6B are schematic views of a retardation plate according to a third embodiment of the invention.

FIG. 7 is a flow diagram of a method for manufacturing the retardation plate of the third embodiment, showing the process steps of the method.

FIG. 8 is a schematic diagram of the configuration of a projector that is an electronic apparatus according to an embodiment of the invention.

### DESCRIPTION OF EXEMPLARY EMBODIMENTS

Embodiments of the invention will now be described with reference to the drawings. The embodiments will describe some forms of the invention by way of example without limiting the invention, and any modifications may be made within the scope and spirit of the invention. For the sake of visibility, the dimensional proportions of the layers and members in the drawings may be varied from those in practice.

### First Embodiment

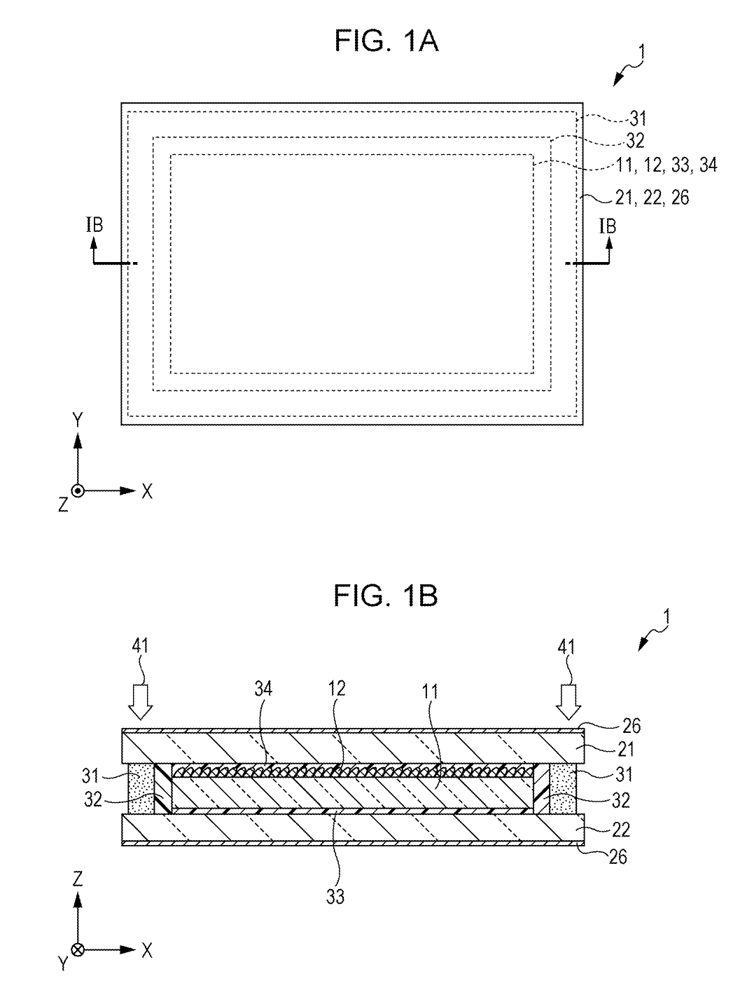

FIGS. 1A and 1B show the structure of a retardation plate according to a first embodiment of the invention. FIG. 1A is a schematic plan view of the retardation plate, and FIG. 1B is a schematic sectional view taken along line IB-IB. The arrows shown in FIG. 1B indicate the direction in which a laser beam enters.

As shown in FIG. 1A, the retardation plate 1 is rectangular. In the drawings, the direction along the long sides of the rectangular retardation plate 1 is defined as the X direction, and the direction along the short sides perpendicular to the X direction is defined as the Y direction. Also, the direction along the thickness of the retardation plate 1, perpendicular to both the X direction and the Y direction, is defined as the Z direction. The retardation plate 1 of the present embodiment will now be described with reference to FIGS. 1A and 1B.

### General Description of Retardation Plate

The retardation plate 1 is an optical component including a retardation film 12 that is air-tightly enclosed so as not to be affected by external moisture. The retardation plate 1 includes a support substrate 11, a retardation film 12, a first protective substrate 21, a second protective substrate 22, an inorganic sealing member 31, and resin members 32, 33 and 34.

The support substrate 11 of the present embodiment is an example of the first substrate of the invention and is made of soda-lime glass, which is a suitable material for the first substrate. The support substrate 11 may be made of other glass material, such as borosilicate glass, non-alkali glass, or quartz glass, as long as it is transparent to visible light.

The retardation film 12 is an inorganic vapor-deposited film formed on a surface of the support substrate 11 by oblique vapor deposition. In other words, the retardation film 12 is disposed on the positive Z direction side of the support substrate 11. The retardation film 12 will be further described in detail later.

The first protective substrate 21 is an example of the second substrate of the invention and is made of soda-lime glass, which is a suitable material for the second substrate. The first protective substrate 21 may be made of other glass material, such as borosilicate glass, non-alkali glass, or quartz glass, as long as it is transparent to visible light. The first protective substrate 21 is disposed to the positive Z direction side of the support substrate 11 so as to cover the retardation film 12. The first protective substrate 21 is larger than the support substrate 11 when viewed from above, and the sides of the first protective substrate 21 project from the sides of the support substrate 11. The first protective substrate 21 is bonded with a resin member 34 having the same refractive index as the soda-lime glass of the first protective substrate 21 to the surface of the support substrate 11 on which the retardation film 12 is disposed.

The second protective substrate 22 is an example of the third substrate of the invention and is made of soda-lime glass, which is a suitable material for the third substrate. The second protective substrate 22 may be made of other glass material, such as borosilicate glass, non-alkali glass, or quartz glass, as long as it is transparent to visible light. The second protective substrate 22 has substantially the same dimensions as the first protective substrate 21 and is disposed on the negative Z direction side of the support substrate 11 so that the support substrate 11 and the retardation film 12 are held between the first protective substrate 21 and the second protective substrate 22. The second protective substrate 22 is bonded to the support substrate 11 with a resin member 33 having the same refractive index as the soda-lime glass of the second protective substrate 22.

As described above, the support substrate 11, the first protective substrate 21 and the second protective substrate 22 are made of the same material (soda-lime glass) and hence have the same linear expansion coefficient. If the first protective substrate 21 and the second protective substrate 22 are made of different materials having different linear expansion coefficient, the retardation plate 1 is undesirably deformed by the difference in thermal expansion between the first protective substrate 21 and the second protective substrate 22. It is therefore advantageous that the support substrate 11, the first protective substrate 21 and the second protective substrate 22 have the same linear expansion coefficient.

Antireflection films 26 are respectively disposed on the positive Z direction side of the first protective substrate 21 and the negative Z direction side of the second protective substrate 22. The surfaces on which the antireflection films 26 are formed can be light entrance surfaces of the retardation plate 1. The antireflection film 26 of the present embodiment is made of magnesium fluoride (MgF₂). The antireflection film 26 may be made of any other material having a lower refractive index than the base material (soda-lime glass) on which the antireflection film 26 is disposed. For example, the antireflection film 26 may be made of fluororesin instead of magnesium fluoride. Also, the antireflection film 26 may be a multilayer film including a low refractive index material layer and a high refractive index material layer. Since the antireflection film 26 suppresses the reflection of light from the light entrance surface, the light transmittance of the retardation plate 1 is increased. The antireflection film 26 is formed on the surface through which light enters.

The inorganic sealing member 31 is formed by locally heating a low melting point glass with a laser beam 41. The inorganic sealing member 31 is in the form of a frame surrounding the support substrate 11 having the retardation film 12 between the first protective substrate 21 and the second protective substrate 22. In other words, the inorganic sealing member 31 is formed along the four edges of the first protective substrate 21 so as to form a rectangle, between the first protective substrate 21 and the second protective substrate 22. Since the inorganic sealing member 31 is formed by a seal dispenser described later, the corners of the sealing member 31 are, strictly, slightly rounded. Thus, the inorganic sealing member 31 binds the first and second protective substrates 21 and 22 together at their outer regions to air-tightly enclose the retardation film 12.

The shape of the inorganic sealing member 31 may be rectangular or circular as long as the inorganic sealing member 31 is disposed between the edges of the first protective substrate 21 and the retardation film 12 and air-tightly binds the first and second protective substrates 21 and 22 together. For example, if the first protective substrate 21 and the second protective substrate 22 are rounded, the inorganic sealing member 31 is preferably rounded.

The inorganic sealing member 31 is made of a low melting point glass containing magnesium oxide (MgO), calcium oxide (CaO), barium oxide (BaO), lithium oxide (Li₂O), sodium oxide (Na₂O), potassium oxide (K₂O), boron oxide (B₂O₃), vanadium oxide (V₂O₅), zinc oxide (ZnO), tellurium oxide (TeO₂), aluminum oxide (Al₂O₃), silicon oxide (SiO₂), lead oxide (PbO), tin oxide (SnO), phosphorus oxide (P₂O₅), ruthenium oxide (Ru₂O), rhodium oxide (Rh₂O), iron oxide (Fe₂O₃), copper oxide (CuO), titanium oxide (TiO₂), tungsten oxide (WO₃), bismuth oxide (Bi₂O₃), or antimony oxide (Sb₂O₃). Examples of such a low melting point glass include vanadium-containing low melting point glass, lead-containing low melting point glass, phosphate-containing low melting point glass, bismuthate-containing low melting point glass, and borosilicate-containing low melting point glass.

The inorganic sealing member 31 has a water-vapor permeability of about 10⁻⁶ g/m²·24 h or less and is thus resistant to moisture. Accordingly, the region sealed by the inorganic sealing member 31 is substantially not affected by external moisture (water penetration). Thus, the retardation film 12 disposed in the region sealed by the inorganic sealing member 31 is protected from external moisture.

The resin member 32 is disposed between the inorganic sealing member 31 and the support substrate 11, and the refractive index of the resin member 32 is adjusted to a value approximately equal to the refractive index of soda-lime glass. As described above, the resin members 32, 33 and 34 are each made of a resin having substantially the same refractive index as soda-lime glass and are disposed in a region air-tightly sealed by the first protective substrate 21, the second protective substrate 22 and the inorganic sealing member 31 so as to inhibit air from being held in the region.

If air is held in the region where the resin member 34 is disposed, that is, the gap (boundary) between the retardation film 12 (support substrate 11) and the first protective substrate 21, light is reflected at this region, and light passing through the retardation plate 1 is attenuated. Similarly, if air is held in the region where the resin member 33 is disposed, that is, the gap between the support substrate 11 and the second protective substrate 22, light is reflected at this region, and, thus, light passing through the retardation plate 1 is attenuated.

The resin members 33 and 34 serve to prevent such reflection. More specifically, the resin member 34 prevents light from reflecting at the gap between the support substrate 11 and the first protective substrate 21, and the resin member 33 prevents light from reflecting at the gap between the support substrate 11 and the second protective substrate 22. Consequently, the light transmittance of the retardation plate 1 is increased.

If the resin members 33 and 34 are made of a resin having a different refractive index from the substrates 11, 21 and 22 (for example, made of soda-lime glass), light is reflected at the boundaries between the substrates 11, 21 and 22 and the resin members 33 and 34, and consequently, light passing through the retardation plate 1 is attenuated. It is therefore desirable that the refractive indices of the resin members 33 and 34 be adjusted to the same refractive index as the substrates 11, 21 and 22 (for example, soda-lime glass).

The resin member 32 disposed between the inorganic sealing member 31 and the support substrate 11 functions not only to prevent reflection of light, but also to facilitate the formation of a highly air-tight inorganic sealing member 31. This will be described in detail later.

### Retardation Film

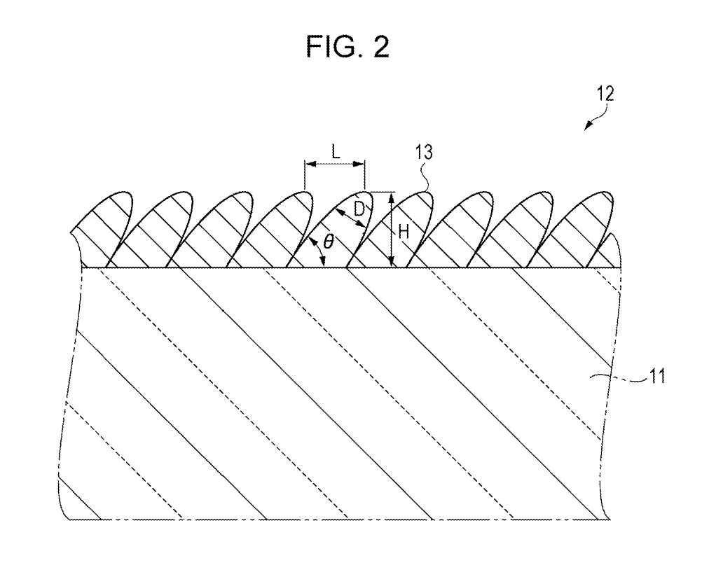

FIG. 2 is a schematic enlarged view of the retardation film 12 formed on the support substrate 11. The retardation film 12 used in the present embodiment will now be described with reference to FIG. 2.

As described above, the retardation film 12 is an inorganic vapor-deposited film formed on a surface of the support substrate 11 by oblique vapor deposition. More specifically, the retardation film 12 is an inorganic vapor-deposited film formed by the deposition of a material (SiO₂) falling obliquely on the surface of the support substrate 11. As shown in FIG. 2, the retardation film 12 has a plurality of oblique columns 13 (columnar structures) tilted with respect to the surface of the support substrate 11. The oblique columns 13 have gaps therebetween. In FIG. 2, H represents the height of the oblique column 13; D represents the width (thickness) of the oblique column 13; θ represents the tilt angle of the oblique column 13; and L represents the pitch of the oblique columns 13.

The retardation film 12 having such a structure is anisotropic as that the refractive index varies with an optical axis extending in the direction in which the deposition material (SiO₂) is deposited. The retardation film 12 has a retardation value R expressed by the equation:

R=(nt−np)×d

In the equation, nt represents the refractive index of the retardation film 12 in the thickness direction, np represents the in-plane average refractive index of the retardation film 12, and d represents the thickness of the retardation film 12. When the shape (height H, width D, tilt angle θ, pitch L, etc.) of the oblique columns 13 is changed, np and d in the equation are varied and, accordingly, the retardation value R is varied. Since the shape of the oblique columns 13 is changed depending on the conditions of their formation, the retardation value R of the retardation film 12 is controlled so as to exhibit desired retardation characteristics by controlling the conditions for forming the oblique columns 13.

The retardation value R is varied by water adsorption in the oblique columns 13 and water penetration (liquid penetration) into the gaps between the oblique columns 13, which vary np. Since the retardation film 12 is made of a water-adsorbent polar material, moisture (water) penetrating the region where the retardation film 12 is disposed is adsorbed to the surface of the retardation film 12 or held in the gaps in the retardation film 12. Thus, the retardation characteristics of the retardation film 12 are varied. Accordingly, it is necessary to inhibit water from penetrating the retardation film 12 to reduce the influence of external moisture.

In addition, since the retardation film 12 is porous due to the gaps between the oblique columns 13, the retardation film 12 is liable to be affected by mechanical impact and damaged. Furthermore, dirt that has penetrated into the gaps is difficult to remove. Accordingly, it is also necessary to reduce the influence of mechanical impact and dirt on the retardation film 12.

The retardation plate 1 has a structure advantageous in solving the above issues. Since the retardation film 12 of the retardation plate 1 is air-tightly enclosed by the moisture-resistant first and second protective substrates 21 and 22 and inorganic sealing member 31, the retardation film 12 is hardly affected by external moisture. In addition, the retardation film 12 is protected from mechanical damage and dirt by the first protective substrate 21.

### Process for Manufacturing the Retardation Plate

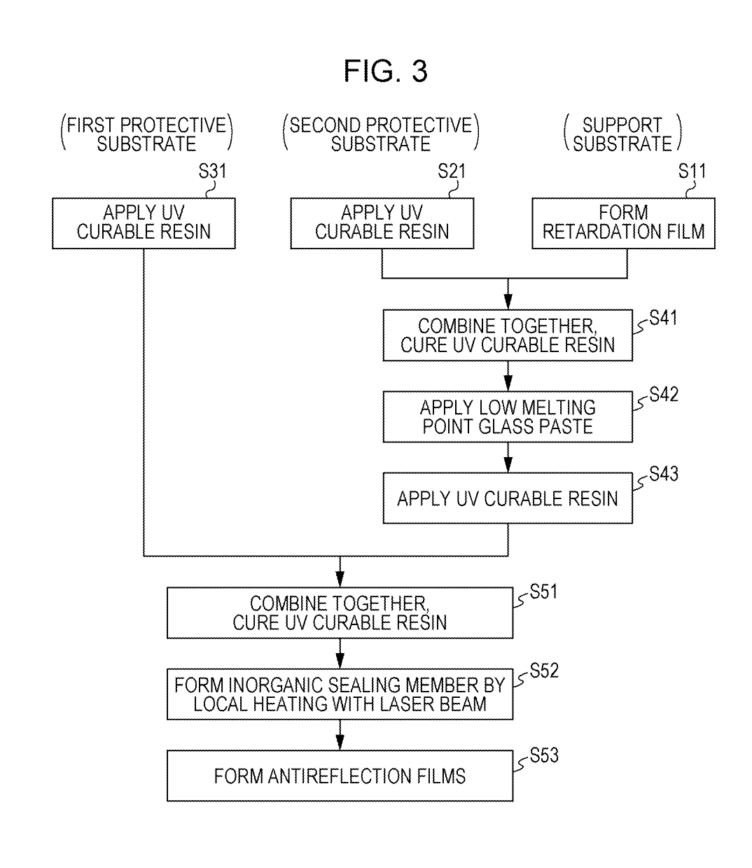

FIG. 3 is a flow diagram of a method for manufacturing the retardation plate of the first embodiment, showing the process steps of the method. The manufacturing process of the retardation plate will now be described with reference to FIG. 3.

In step S11, the retardation film 12 is formed on the support substrate 11 by oblique vapor deposition of, for example, silicon oxide (SiO₂). The retardation film 12 may be formed of any other inorganic material transparent to visible light, such as silicon oxide, tantalum oxide (Ta₂O₅), aluminum oxide (Al₂O₃), titanium oxide (TiO₂), hafnium oxide (HfO₂), or tungsten oxide (WO₃). The retardation film 12 may be a multilayer film including layers of these inorganic materials. Alternatively, the retardation film 12 may be a multilayer film including an organic layer on the inorganic vapor-deposited film.

Oblique vapor deposition can be performed by, for example, sputtering, electron beam vapor deposition, or ion assisted vapor deposition. By obliquely depositing a transparent inorganic material onto the surface of the support substrate 11 using a vacuum vapor deposition apparatus, the retardation film 12 is formed.

In Step S21, a UV curable resin is applied by, for example, screen printing or using a dispenser to the surface of the second protective substrate 22 that will come into contact with the support substrate 11. The UV curable resin will be cured in the below-described Step S41 to form the resin member 33.

In Step S31, a UV curable resin is applied by, for example, screen printing or using a dispenser to the surface of the first protective substrate 21 that will come into contact with the retardation film 12. The UV curable resin will be cured in the below-described Step S51 to form the resin member 34.

In Step S41, the second protective substrate 22 and the support substrate 11 are combined together, and the UV curable resin is cured by UV irradiation to form the resin member 33. Consequently, the second protective substrate 22 adheres to the support substrate 11 with the resin member 33.

In Step S42, a low melting point glass paste is applied to the second protective substrate 22 from a dispenser to form a low melting point glass precursor. The low melting point glass precursor is formed in the form of a frame surrounding the support substrate 11 on the second protective substrate 22. The low melting point glass precursor will be melted and solidified to form the inorganic sealing member 31 in Step S52.

In Step S43, a UV curable resin is applied (dropped) to the space between the support substrate 11 and the low melting point glass precursor by, for example, an ink jet method or using a dispenser. The UV curable resin will be cured in the below-described Step S51 to form the resin member 32.

In Step S51, the first protective substrate 21 is combined to the surface having the retardation film 12 of the support substrate 11 bound to the second protective substrate 22, and the UV curable resin is cured by UV irradiation to form the resin members 32 and 34. Consequently, the first protective substrate 21 adheres to the surface having the retardation film 12 of the support substrate 11 with the resin member 34. Also, the resin member 32 is formed between the support substrate 11 and the low melting point glass precursor. The resin members 32, 33 and 34 may be formed of a thermosetting resin or a resin that will be cured by combination of light and heat, instead of the UV curable resin.

In Step S52, the low melting point glass precursor is melted to form the inorganic sealing member 31 by local heating with a laser beam 41. The laser beam 41 comes from the direction of the first protective substrate 21 and acts locally on the low melting point glass precursor (inorganic sealing member 31), as shown in FIG. 1B.

The retardation film 12 is not irradiated with the laser beam 41 and is therefore not deteriorated by the local heating with the laser beam 41. On the other hand, the resin member 32 adjacent to the inorganic sealing member 31 is deteriorated by the local heating. However, the retardation film 12 is apart from the deteriorated resin member 32, and thus, the retardation characteristics of the retardation film 12 are not affected by the deteriorated resin member 32.

If air is held between the support substrate 11 and the inorganic sealing member 31 because of the absence of the resin member 32, the air is expanded by the local heating and presses the low melting point glass precursor, thus forming a defect in the low melting point glass precursor. Furthermore, the defect may be reflected in the inorganic sealing member 31, and the airtightness of the inorganic sealing member 31 may be degraded.

The resin member 32 serves to expel air from the gap between the support substrate 11 and the inorganic sealing member 31. By expelling air from the gap, the influence of the air caused by local heating with a laser beam is reduced, and consequently, a highly air-tight inorganic sealing member 31 is formed.

The influence of the air held between the support substrate 11 and the inorganic sealing member 31 can also be reduced by irradiation with a laser beam 41 under reduced pressure. In this instance, the laser beam irradiation under reduced pressure allows a highly air-tight inorganic sealing member 31 to be formed without forming the resin member 32.

In order to from a highly air-tight inorganic sealing member 31, the resin member 32 may be provided between the support substrate 11 and the inorganic sealing member 31, or the low melting point glass precursor may be locally heated with a laser beam 41 under reduced pressure.

In Step S53, magnesium fluoride is deposited on the first protective substrate 21 and the second protective substrate 22 to form the antireflection films 26.

The retardation plate 1 has the following effects.

Since the retardation film 12 is air-tightly enclosed by the moisture-resistant first and second protective substrates 21 and 22 and inorganic sealing member 31, the retardation film 12 is hardly affected by external moisture (water).

The retardation film 12 is protected from mechanical damage and dirt by the first protective substrate 21.

Since the retardation plate 1 is provided with the antireflection films 26 on the light entrance surfaces thereof, the light transmittance of the retardation plate 1 is increased.

Since the resin member 34 having the same refractive index as the support substrate 11 and the first protective substrate 21 is formed in the gap between the retardation film 12 (support substrate 11) and the first protective substrate 21, light is prevented from being reflected at the gap and the light transmittance of the retardation plate 1 is increased.

Also, since the resin member 33 having the same refractive index as the support substrate 11 and the second protective substrate 22 is formed in the gap between the support substrate 11 and the second protective substrate 22, light is prevented from being reflected at the gap and the light transmittance of the retardation plate 1 is increased.

The resin member 32 is formed between the support substrate 11 and the inorganic sealing member 31 to expel air from the gap between the support substrate 11 and the inorganic sealing member 31. Thus, the precursor of the inorganic sealing member 31 is prevented from being pressed by thermal expansion of air in the gap caused by the local laser beam heating, and the occurrence of defects in the resulting inorganic sealing member 31 is reduced. Consequently, the inorganic sealing member 31 has high airtightness.

Since the support substrate 11, the first protective substrate 21 and the second protective substrate 22 are made of the same material and accordingly have the same linear expansion coefficient, the retardation plate 1 is prevented from being deformed by the difference in thermal expansion among these substrates 11, 21 and 22.

### Second Embodiment

### General Description of Retardation Plate

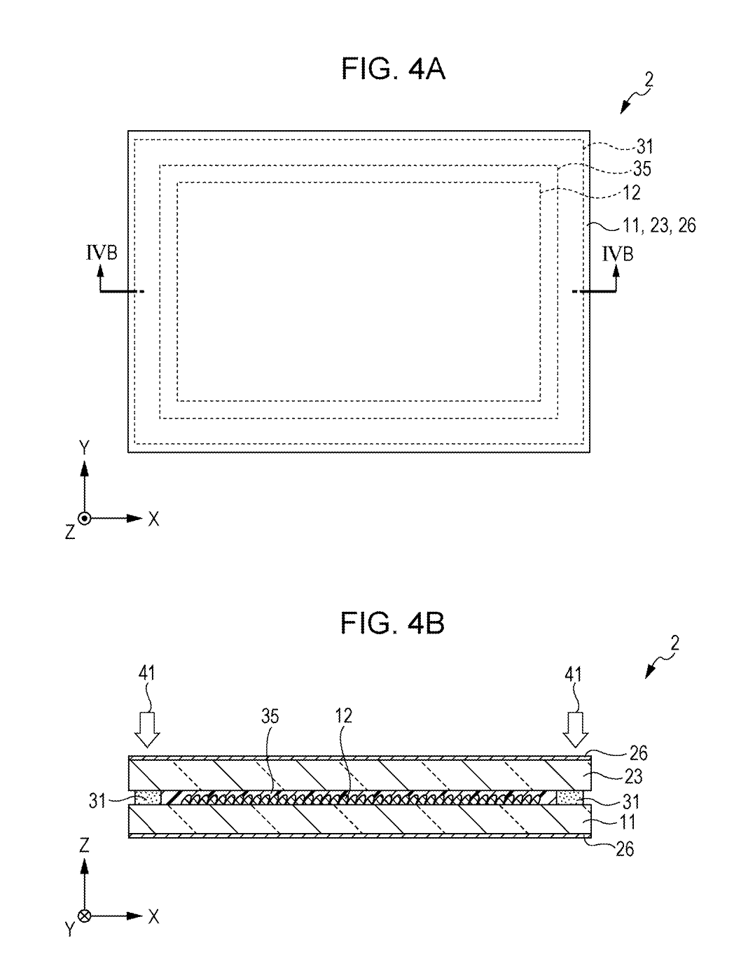

FIGS. 4A and 4B show the structure of a retardation plate according to a second embodiment of the invention. FIG. 4A is a schematic plan view of the retardation plate, and FIG. 4B is a schematic sectional view taken along line IVB-IVB.

The retardation plate 2 of the second embodiment is different from that of the first embodiment in that a single protective substrate is used for air-tightly enclosing the retardation film. In FIGS. 4A and 4B, the same components as in the first embodiment are designated by the same reference numerals. The retardation plate 2 of the present embodiment will now be described with reference to FIGS. 4A and 4B.

The retardation plate 2 includes a support substrate 11, a retardation film 12, a protective substrate 23, an inorganic sealing member 31, and a resin member 35. The protective substrate 23 is an example of the second substrate of the invention and is made of soda-lime glass, which is a suitable material for the second substrate. The protective substrate 23 may be made of other glass material, such as borosilicate glass, non-alkali glass, or quartz glass, as long as it is transparent to visible light. The protective substrate 23 has substantially the same shape as the support substrate 11 when viewed from above. The protective substrate 23 covers the retardation film 12 in such a manner that the retardation film 12 lies between the support substrate 11 and the protective substrate 23.

Since the protective substrate 23 is made of the same material (soda-lime glass) and accordingly has the same linear expansion coefficient as the support substrate 11, the retardation plate 2 is prevented from being deformed by the difference in thermal expansion between the protective substrate 23 and the support substrate 11.

The resin member 35 is disposed between the support substrate 11 and the protective substrate 23 so as to cover the retardation film 12, and the refractive index of the resin member 35 is adjusted to a value approximately equal to the refractive index of soda-lime glass. In other words, the region sealed by the support substrate 11, the protective substrate 23 and the inorganic sealing member 31 is filled with the resin member 35 to expel air from the region.

The resin member 35 expels air from the gap between the retardation film 12 and the protective substrate 23. Consequently, reflection of light from the gap is prevented, and the light transmittance of the retardation plate 2 is increased. The resin member 35 expels air from the gap between the inorganic sealing member 31 and the retardation film 12, so that the precursor of the inorganic sealing member 31 is prevented from being pressed by thermal expansion of the air in the gap caused by local laser beam heating, and the occurrence of defects in the resulting inorganic sealing member 31 is reduced.

### Process for Manufacturing the Retardation Plate

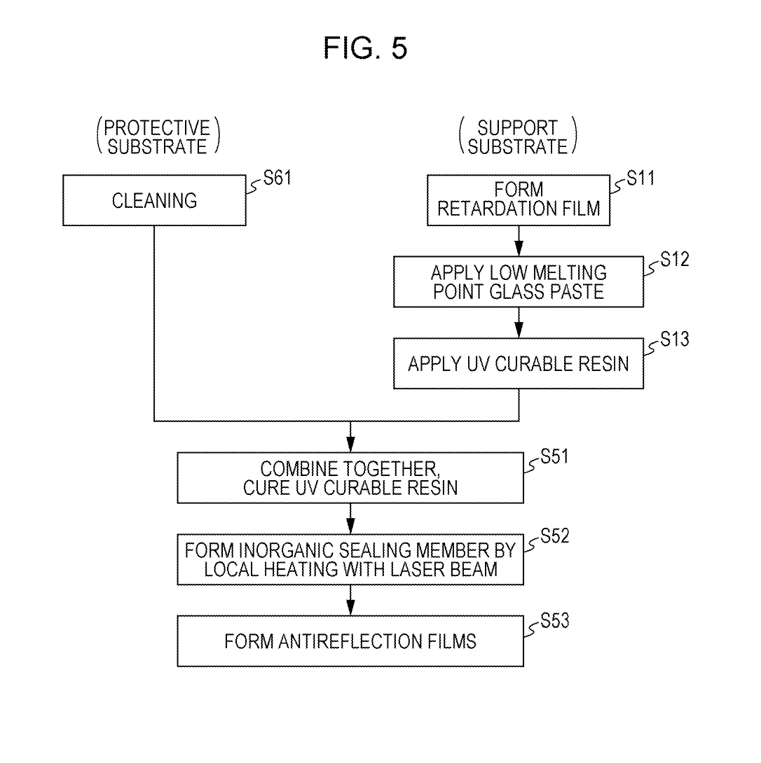

FIG. 5 is a flow diagram of a method for manufacturing the retardation plate of the second embodiment, showing the process steps of the method. The manufacturing process of the retardation plate will now be described with reference to FIG. 5.

In step S11, the retardation film 12 is formed on the support substrate 11 by oblique vapor deposition of, for example, silicon oxide.

In Step S12, a low melting point glass paste is applied to the support substrate 11 from a dispenser to form a frame-shaped low melting point glass precursor surrounding the retardation film 12. The low melting point glass precursor will be melted and solidified to form the inorganic sealing member 31 in Step S52.

In Step S13, a UV curable resin is applied (dropped) to the region inside the frame-shaped low melting pint glass precursor by, for example, an ink jet method or using a dispenser. The UV curable resin will be cured in the below-described Step S51 to form the resin member 35.

In Step S61, the protective substrate 23 is cleaned (degreased) with a cleaning agent containing a surfactant.

In Step S51, the protective substrate 23 and the support substrate 11 are combined together, and the UV curable resin is cured by UV irradiation to form the resin member 35. Consequently, the protective substrate 23 adheres to the support substrate 11 with the resin member 35.

In Step S52, the low melting glass precursor is melted to form the inorganic sealing member 31 by local heating with a laser beam 41. The laser beam 41 comes from the direction of the protective substrate 23 and acts locally on the low melting point glass precursor (inorganic sealing member 31), as shown in FIG. 4B.

The retardation film 12 is not irradiated with the laser beam 41 and is therefore not deteriorated by the local heating with the laser beam 41. On the other hand, the resin member 35 adjacent to the inorganic sealing member 31 is deteriorated by the local heating. However, the retardation film 12 is apart from the deteriorated resin member 35, and thus, the retardation characteristics of the retardation film 12 are not affected by the deteriorated resin member 35.

In Step S53, magnesium fluoride is deposited on the support substrate 11 and the protective substrate 23 to form the antireflection films 26.

The retardation plate 2 of the present embodiment has the following effects in addition to the effects of the first embodiment. Since the retardation film 12 is air-tightly enclosed by the moisture-resistant support substrate 11, protective substrate 23 and inorganic sealing member 31, the retardation film 12 is hardly affected by external moisture (water).

Since the number of the protective substrates for air-tightly enclosing the retardation film 12 is one and is smaller than that in the first embodiment by one, a less expensive and thinner retardation plate 2 is provided.

Since the support substrate 11 and the protective substrate 23 are made of the same material and accordingly have the same linear expansion coefficient, the retardation plate 2 is prevented from being deformed by the difference in thermal expansion between these substrates 11 and 23.

The region sealed by the support substrate 11, the protective substrate 23 and the inorganic sealing member 31 is filled with the resin member 35 to expel air from the region. Thus, the reflection of light by air in that region is prevented, and the light transmittance of the retardation plate 2 is increased. In addition, the precursor of the inorganic sealing member 31 is prevented from being pressed by thermal expansion of the air in the region caused by the local laser beam heating, and the occurrence of defects in the resulting inorganic sealing member 31 is reduced.

### Third Embodiment

### General Description of Retardation Plate

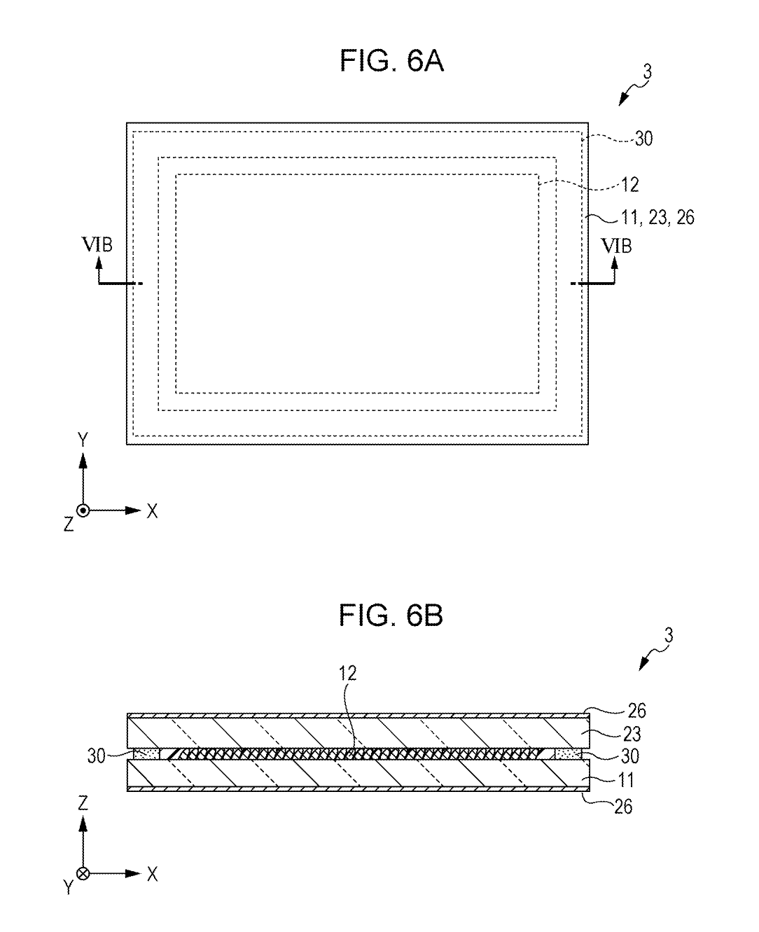

FIGS. 6A and 6B show the structure of a retardation plate according to a third embodiment of the invention. FIG. 6A is a schematic plan view of the retardation plate, and FIG. 6B is a schematic sectional view taken along line VIB-VIB. The retardation plate of the third embodiment is different from that of the second embodiment in that the inorganic sealing member is made of solder, and in that the resin member is not provided. The retardation plate 3 of the present embodiment will now be described with reference to FIGS. 6A and 6B.

The retardation plate 3 includes a support substrate 11, a retardation film 12, a protective substrate 23, and an inorganic sealing member 30. The inorganic sealing member 30 is made of a Sn—Pb alloy (hereinafter referred to as SnPb solder) containing, for example, Zn, Sb, Al, Ti, Si, Cu, Bi, Fe or Ni, which is a suitable material for the inorganic sealing member 30. The SnPb solder has a melting point of about 224° C. The elements such as Zn, Sb, Al, Ti, Si, Cu, Bi, Fe and Ni have high affinity for oxygen in glass. By adding such an element to the solder, the adhesion between the solder and glass can be enhanced.

The solder is not limited to the Sn—Pb alloy as long as the solder contains an element having high affinity for oxygen, such as Zn, Sb, Al, Ti, Si, Cu, Bi, Fe or Ni. For example, the inorganic sealing member 30 may be made of a Sn—Ag, Sn—Ag—In, Sn—Cu, Sn—Ag—Cu, Sn—Zn—Ti, Sn—Zn, or Sn—Sb alloy. These solders have as high moisture resistance as low melting point glass.

Accordingly, even when the support substrate 11 and the protective substrate 23 are bound together with the highly moisture-resistant SnPb solder to air-tightly enclose the retardation film 12, the retardation film 12 is hardly affected by external moisture.

### Process for Manufacturing the Retardation Plate

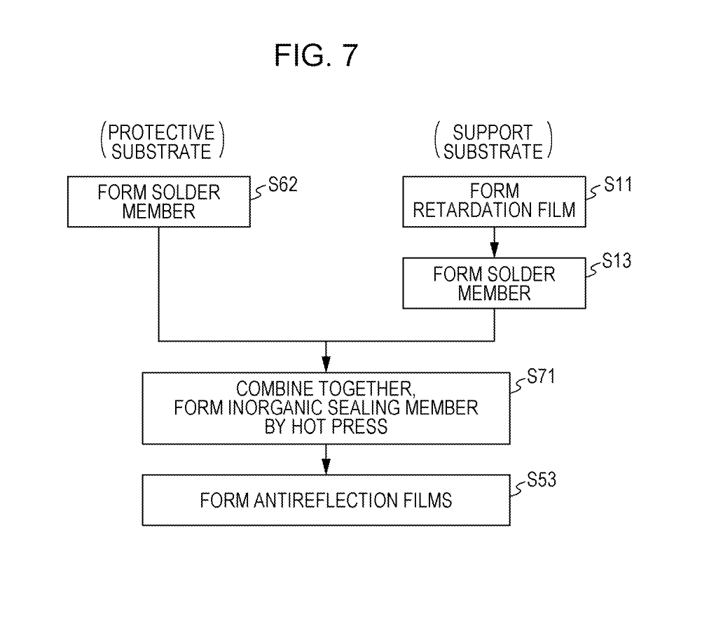

FIG. 7 is a flow diagram of a method for manufacturing the retardation plate of the third embodiment, showing the process steps of the method. The manufacturing process of the retardation plate will now be described with reference to FIG. 7.

In step S11, the retardation film 12 is formed on the support substrate 11 by oblique vapor deposition of, for example, silicon oxide.

In Step S13, a SnPb solder frame is formed in an outer region of the surface of the support substrate 11 using an ultrasonic soldering machine. The ultrasonic soldering machine is used for soldering a glass substrate or the like while irradiating the substrate with ultrasonic waves. Since the bonding surface of the substrate is made clean by cavitation produced by the ultrasonic waves, the solder can be bonded to the substrate.

In Step S62, a SnPb solder frame is formed in an outer region of the surface of the protective substrate 23 using an ultrasonic soldering machine. The SnPb solder frame formed on the protective substrate 23 and the SnPb solder frame formed on the support substrate 11 have the same shape in plan view, and will be bonded together to form the inorganic sealing member 30 in Step S71.

In Step S71, the support substrate 11 and the protective substrate 23 are combined together and heated to a temperature higher than or equal to the melting point (224° C.) of the SnPb solder while being pressed with a hot press machine. Thus, the SnPb solder frame of the protective substrate 23 and the SnPb solder frame of the support substrate 11 are melted and solidified to be bonded together. Thus the inorganic sealing member 30 is formed.

The inorganic sealing member 30 may be formed by local heating with a laser beam, furnace annealing in a furnace, lamp annealing using a halogen heater as a heat source, or annealing in a clean oven, instead of hot press.

Since the support substrate 11 and the protective substrate 23 are bonded together while being pressed, the retardation film 12 and the protective substrate 23 adhere tightly to each other. Hence, air does not penetrate between the retardation film 12 and the protective substrate 23 even though a resin member is not provided between the retardation film 12 and the protective substrate 23. Thus, the reflection of light by the air is prevented, and the light transmittance of the retardation plate 3 is increased. Instead of bonding with pressing, the support substrate 11 and the protective substrate 23 may be bonded together under reduced pressure. This can also increase light transmittance.

The retardation plate 3 of the present embodiment has the following effects in addition to the effects of the second embodiment.

Since the solder forming the inorganic sealing member 30 has as high moisture resistance as low melting point glass, the region sealed by the highly moisture-resistant support substrate 11, protective substrate 23 and inorganic sealing member 30 is substantially not affected by external moisture (water penetration). Thus, the retardation film 12 disposed in the sealed region is protected from external moisture.

Since the support substrate 11 and the protective substrate 23 are bonded together while being pressed, air is inhibited from being held between the retardation film 12 and the protective substrate 23 even though a resin member is not provided between the retardation film 12 and the protective substrate 23. Thus, the reflection of light by the air is prevented, and the light transmittance of the retardation plate 3 is increased.

It will be appreciated that the invention is not limited to the above-disclosed embodiments, and that various modifications may be made without departing from the spirit and scope of the invention. Modifications of the embodiments will be described below.

### Modification

The inorganic sealing member 30 of the third embodiment is made of solder. However, the inorganic sealing member 30 may be made of any metal. The inorganic sealing member 30 may be formed of a metal other than solder, such as aluminum (Al), an aluminum alloy, titanium (Ti), chromium (Cr), molybdenum (Mo), or tungsten (W), by vacuum deposition, such as vapor deposition or sputtering. Also, the inorganic sealing member 30 may be a multilayer film of these metals. Alternatively, the inorganic sealing member 30 may be made of a metal film of Ni, Au, Cu or the like formed by electroless plating or any other plating technique, or a multilayer composite of these metal films.

These metals are melted and solidified by local heating with a laser beam, thus binding the glass substrates together. Also, since the metals have as high moisture resistance as the low melting point glass, the influence of external air is reduced by air-tight sealing using the inorganic sealing member 30 made of such a metal.

### Electronic Apparatus

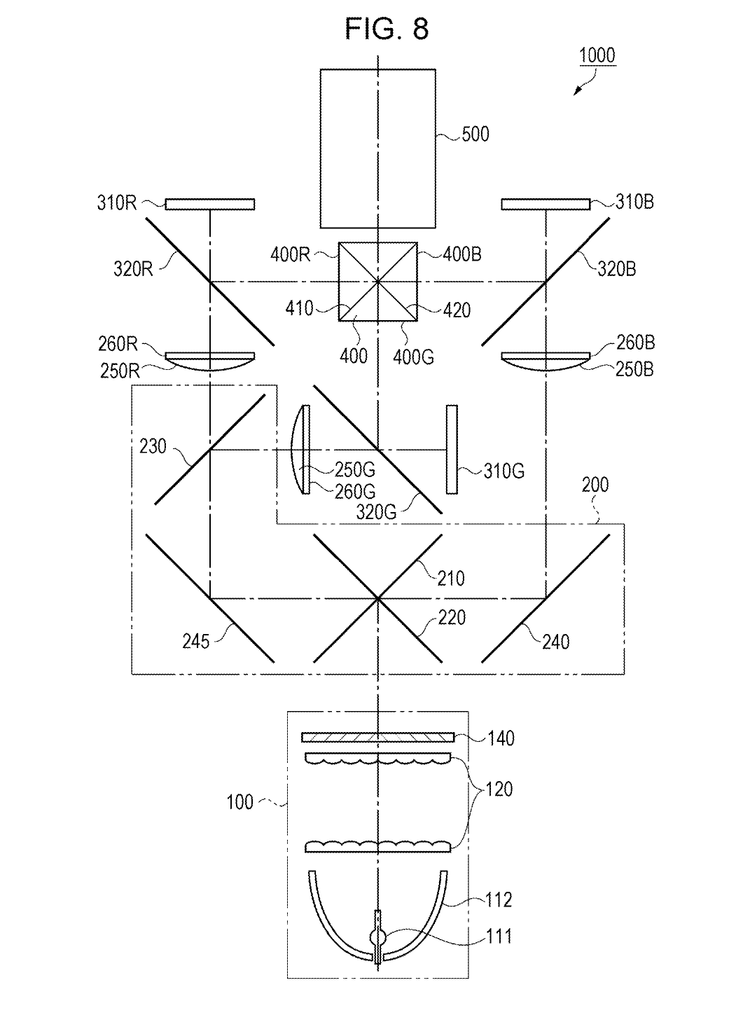

An electronic apparatus including the retardation plate of any of the embodiments and modifications will now be described with reference to FIG. 8. FIG. 8 is a plan view of the optical system of a three-panel projector.

The projector 1000 of the present embodiment includes three reflective optical modulators (reflective liquid crystal display devices) 310R, 310G and 310B for red (R) light, green (G) light and blue (B) light, respectively. The reflective optical modulators 310R, 310G and 310B each modulate a beam of light from a light source 111 into image light according to image signals, and the image light is enlarged and projected on a screen or the like.

The projector 1000 includes a lighting optical system 100, a color separation optical system 200, paralleling lenses 250R, 250G and 250B, retardation plates 260R, 260G and 260B, polarization beam splitters 320R, 320G and 320B, reflective optical modulators 310R, 310G and 310B, a cross dichroic prism 400 for photosynthesis, and an optical projection unit 500.

The lighting optical system 100 includes a light source 111 that is an ultrahigh-pressure mercury-vapor lamp, a reflector 112 that is a parabolic mirror, lens arrays 120, and a polarization modulator 140. A radial light beam emitted from the light source 111 is divided into a plurality of portions of the light beam by the reflector 112 and the lens arrays 120. The divided portions of the light beam are modulated into S-polarized light by the polarization modulator 140 and enter the color separation optical system 200.

The color separation optical system 200 separates the light beam coming from the lighting optical system 100 into three color lights of R, G and B. The color separation optical system 200 includes a B light-reflecting dichroic mirror 210, a RG light-reflecting dichroic mirror 220, a G light-reflecting dichroic mirror 230, and reflection mirrors 240 and 245.

The B light component of the light beam from the lighting optical system 100 is reflected at the B light-reflecting dichroic mirror 210 and further reflected at the reflection mirror 240, thus traveling to the paralleling lens 250B. The R and G light components of the light beam from the lighting optical system 100 are reflected at the RG light-reflecting dichroic mirror 220, and further reflected at the reflection mirror 245, thus traveling to the G light-reflecting dichroic mirror 230. The G light component is reflected at the G light-reflecting dichroic mirror 230 to travel to the paralleling lens 250G, and the R light component passes through the G light-reflecting dichroic mirror 230 to travel to the paralleling lens 250R.

The paralleling lenses 250R, 250G and 250B convert the portions of the light beam emitted from the lighting optical system 100 into substantially parallel beams that illuminate the corresponding one of the reflective optical modulators 310R, 310G and 310B. The retardation plates 260R, 260G and 260B are any of the retardation plates of the first to third embodiments and the modification, and are therefore protected from external moisture. The retardation plates 260R, 260G and 260B each convert the color light (S-polarized light) passing through the corresponding one of the paralleling lenses 250R, 250G and 250B into P-polarized light.

The polarization beam splitter 320G transmits the G light (P-polarized light) from the retardation plate 260G to the reflective optical modulator 310G. The reflective optical modulator 310G modulates the G light into S-polarized light and reflects it to the polarization beam splitter 320G. The polarization beam splitter 320G reflects the S-polarized B light to cross dichroic prism 400.

The polarization beam splitters 320R and 320B have the same structure and function in the same manner as the polarization beam splitter 320G. More specifically, the polarization beam splitter 320R and 320B transmit the R light (P-polarized light) and the B light (P-polarized light) from the retardation plates 260R and 260B to the reflective optical modulators 310R and 310B, respectively, and then reflect the S-polarized light of the R and B light reflected at the reflective optical modulators 310R and 310B to the cross dichroic prism 400, respectively.

The cross dichroic prism 400 includes four triangular prisms that are bonded together so as to form a square pole having a substantially square section, and dielectric films 410 and 420 along the bonded surfaces forming an X-shape. The dielectric film 410 transmits G light and reflects R light, and the dielectric film 420 transmits G light and reflects B light. The cross dichroic prism 400 receives modulated color lights from the polarization beam splitters 320R, 320G and 320B at the light entrance surfaces 400R, 400G and 400B, respectively. Thus, the color lights are synthesized to image light in the cross dichroic prism 400 and emitted to the optical projection unit 500. The image light is enlarged and projected by the optical projection unit 500.

Since the projector 1000, which is an embodiment of the electronic apparatus of the invention, includes the retardation plates 260R, 260G and 260B according to an embodiment of the invention, the display quality is prevented from being degraded by external moisture, and the projector 1000 is thus resistant to moisture.

The retardation plate of an embodiment of the invention may be applied to other electronic apparatuses, such as a projector of another type using DLP (Digital Light Processing) for optical modulation and a rear projection TV set, in addition to the above-described projector using liquid crystal devices for optical modulation. Also, the retardation plate of an embodiment of the invention may be used in other electronic apparatuses in which optical discs, such as DVD and CD, are used.

This application claims priority from Japanese Patent Application No. 2012-100772 filed in the Japanese Patent Office on Apr. 26, 2012, the entire disclosure of which is hereby incorporated by reference in its entirely.

What is claimed is:

1. A retardation plate comprising:
a first substrate;
a retardation film disposed on the first substrate;
a second substrate larger than the first substrate when viewed from above, the second substrate covering the retardation film;
a third substrate disposed such that the first substrate lies between the second substrate and the third substrate; and
a inorganic sealing member disposed between the edge of the second substrate and the retardation film, the inorganic sealing member sealing the retardation film between the second substrate and the third substrate.

2. A retardation plate comprising:
a first substrate;
a retardation film disposed on the first substrate;
a second substrate disposed such that the retardation film lies between the first substrate and the second substrate; and
a inorganic sealing member disposed between the edge of the first substrate and the retardation film, the inorganic sealing member sealing the retardation film between the first substrate and the second substrate.

3. The retardation plate according to claim 1, wherein the inorganic sealing member is made of a metal or a low melting point glass having a lower melting point than the first substrate.

4. The retardation plate according to claim 2, wherein the inorganic sealing member is made of a metal or a low melting point glass having a lower melting point than the first substrate.

5. The retardation plate according to claim 1, wherein the retardation film is an inorganic vapor-deposited film formed on a surface of the first substrate by oblique vapor deposition.

6. The retardation plate according to claim 2, wherein the retardation film is an inorganic vapor-deposited film formed on a surface of the first substrate by oblique vapor deposition.

7. The retardation plate according to claim 1, further comprising a resin member between the first substrate and the inorganic sealing member.

8. The retardation plate according to claim 1, wherein the first substrate and the second substrate have the same linear expansion coefficient.

9. The retardation plate according to claim 2, wherein the first substrate and the second substrate have the same linear expansion coefficient.

10. The retardation plate according to claim 1, wherein the first substrate, the second substrate and the third substrate have the same linear expansion coefficient.

11. The retardation plate according to claim 1, further comprising an antireflection film on at least one of the surface of the second substrate opposite the first substrate and the surface of the third substrate opposite the first substrate.

12. The retardation plate according to claim 2, further comprising an antireflection film on at least one of the surface of the first substrate opposite the retardation film and the surface of the second substrate opposite the first substrate.

13. An electronic apparatus comprising the retardation plate as set forth in claim 1.
